(19) United States
(12) Patent Application Publication
(10) Pub. No.: US 2026/0335050 A1
(43) Pub. Date: Oct. 29, 2026

(54) NON-ADHESIVE DENTAL IMPLANT

(71) Applicant: CYBERMED INC., Daejeon (KR)

(72) Inventors: Dong Ki PARK, Daejeon (KR); Cheol Young KIM, Daejeon (KR)

(21) Appl. No.: 19/124,371

(22) PCT Filed: Jan. 31, 2023
(86) PCT No.: PCT/KR2023/001380

§ 371 Date: Apr. 25, 2025

(30) Foreign Application Priority Data
Nov. 1, 2022 (KR) 10-2022-0143927

(51) Int. Cl. A61C 8/00

(52) U.S. Cl. CPC A61C 8/0068; A61C 8/0057

(57) ABSTRACT

The present invention relates to a non-adhesive dental implant and, more specifically, to a non-adhesive dental implant comprising: an abutment which includes an upper part insertively fastened to a prosthesis, a lower part insertively fastened to a fixture, and an inclined part connecting the upper part and the lower part, and which has a first screw hole formed in the center thereof; the prosthesis which has, at the inner lower side thereof, a coupling part to which the upper part of the abutment is insertively fastened, which has a second screw hole formed at the inner upper side thereof, and which includes a coupling protrusion part connecting the coupling part and the second screw hole; and an abutment screw, which passes through the first and second screw holes and is insertively fastened thereto.

### TECHNICAL FIELD

The present disclosure relates to a non-adhesive dental implant that improves the convenience of patients and practitioners.

### BACKGROUND ART

Dental implants are widely used to replace damaged or missing natural teeth. In these implants, a dental fixture is placed into a patient's jawbone to replace a natural tooth. An abutment may then be attached to a fixture to form a core for a portion of an artificial tooth that will protrude into the patient's mouth through the soft gum tissue from the bone tissue. A prosthesis (crown) may be ultimately seated on top of the abutment.

Conventional implants may be classified into screw-retained and adhesive (cement)-retained types depending on a method for fixing a prosthesis. Screw-retained implants are a method in which the prosthesis is fixed by a screw, while adhesive-retained implants are a method in which the prosthesis is fitted into an abutment and fixed to the abutment using dental adhesive.

In the case of conventional adhesive-retaining implants, there is a risk of periodontal inflammation and the inconvenience of removing the prosthesis when repair is required after the prosthesis is installed.

As an example of the screw-retained implants, Korean Patent NO. 10-2427069 (Jul. 26, 2022) discloses an implant crown fastening structure including: an abutment having a cutting portion and a protrusion portion formed on an upper outer side; and a crown having an abutment coupling part formed on an inner lower side, which an upper side of the abutment is inserted into and fastened to, and an abutment seating groove formed in the abutment coupling part, into which the protrusion portion of the abutment may be seated. The implant crown fastening structure described above is characterized by a structure in which an upper circumferential surface of the abutment is spread apart by the cutting portion during a process of fastening a screw, and thus, the cement (adhesive) bonding process that is generally used to bond the crown and the abutment is omitted, thereby achieving a firm and close bond. However, when the screw is fastened, an upper side of the abutment opens, causing an outward force to be applied to the crown in this implant crown fastening structure. Accordingly, if an internal space formed in the crown is narrower than the space created by the upper side of the abutment being pushed apart by the screw, the problem of crown breakage may occur.

### PRIOR ART DOCUMENT

Korean Patent NO. 10-2427069 (Jul. 26, 2022)

### DETAILED DESCRIPTION OF INVENTION

### Technical Problems One object of the present disclosure is to provide a dental implant in which there is no risk of damage to a prosthesis and the prosthesis and an abutment are easily separable.

### Technical Solution

In one aspect, the present disclosure provides a dental implant including: an abutment including an upper part inserted into and fastened to a prosthesis, a lower part inserted into and fastened to a fixture, an inclined part connecting the upper part and the lower part, and a first screw hole formed in a center thereof; the prosthesis including a coupling part formed on an inner lower side, which the upper part of an abutment is inserted into and fastened to, a second screw hole formed on an inner upper side, and a coupling protrusion part connecting the coupling part and the second screw hole; and an abutment screw inserted and fastened through the first and second screw holes, wherein the upper part of the abutment includes a plurality of top protruding parts, which are arranged to be spaced apart from each other at an upper end portion having a horizontal surface shape and protrude upward, the top protruding parts include grooves recessed from outer sides thereof, and the coupling protrusion part includes a protrusion protruding into an interior of the prosthesis such that the protrusion is inserted into and fastened to the grooves of the top protruding parts.

### Effect of Invention

A dental implant according to an embodiment of the present disclosure has no risk of damage to a prosthesis and allows simple separation of the prosthesis and an abutment.

### BRIEF DESCRIPTION OF THE DRAWING

FIG. 1 is a drawing schematically showing a state before fastening of a dental implant according to one embodiment of the present disclosure.

FIG. 2 is a schematic drawing of an abutment of a dental implant according to one embodiment of the present disclosure.

FIG. 3 is a schematic drawing of a prosthesis of a dental implant according to one embodiment of the present disclosure.

FIG. 4 is a drawing schematically showing a fastened state of a dental implant according to one embodiment of the present disclosure.

FIG. 5 is an enlarged view of a portion indicated by a dotted circle in FIG. 4.

### BEST MODE FOR CARRYING OUT THE INVENTION

The present disclosure relates to a non-adhesive dental implant that improves the convenience of patients and practitioners.

Hereinafter, various embodiments of the present disclosure will be described in detail with reference to the drawings.

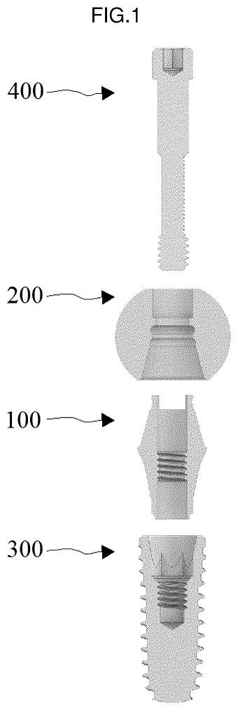

FIG. 1 is a drawing schematically showing a state before fastening of a dental implant according to one embodiment of the present disclosure.

Referring to FIG. 1, a dental implant according to one embodiment of the present disclosure may include an abutment 100, a prosthesis 200, and an abutment screw 400, and may further include a fixture 300.

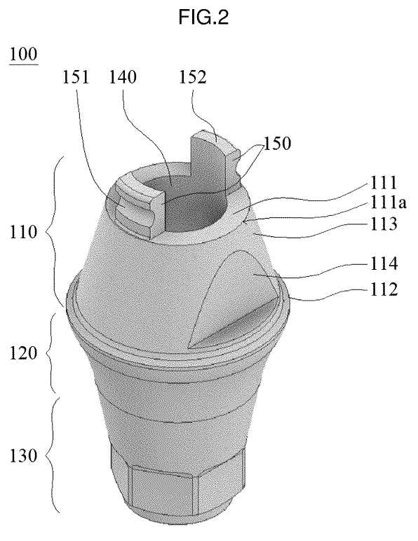

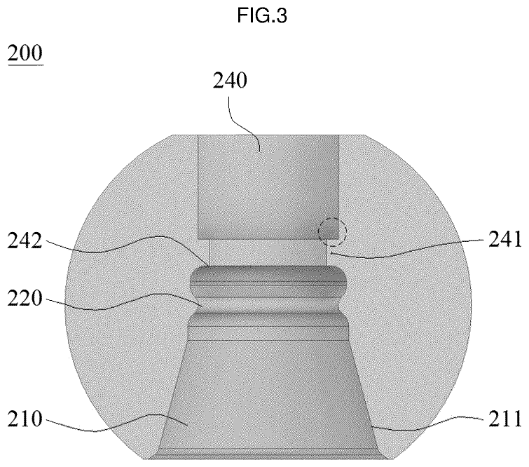

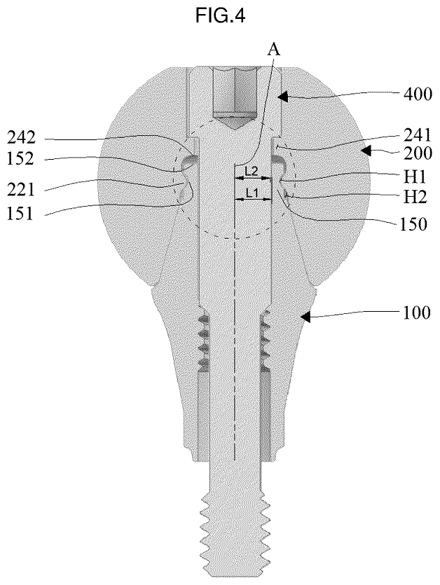

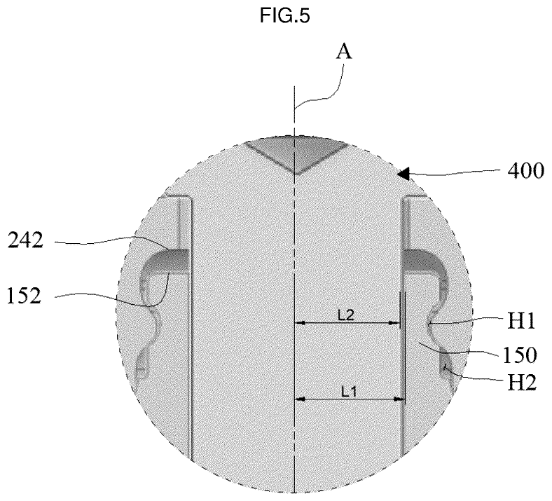

FIG. 2 is a drawing schematically showing an abutment of a dental implant according to one embodiment of the present disclosure, FIG. 3 is a drawing schematically showing a prosthesis of a dental implant according to one embodiment of the present disclosure, FIG. 4 is a drawing schematically showing a fastened state of a dental implant according to one embodiment of the present disclosure, and FIG. 5 is an enlarged view of a portion indicated by a dotted circle in FIG. 4.

Hereinafter, the abutment 100, the prosthesis 200, the abutment screw 400, and the fixture 300 of the dental implant according to one embodiment of the present disclosure will be described in more detail with reference to FIGS. 2 to 5.

The abutment 100 according to one specific example of the present disclosure may include an upper part 110, an inclined part 120, and a lower part 130.

The upper part 110 of the abutment 100 may be configured to be inserted into and fastened to the prosthesis 200 which will be described later.

In one embodiment, the upper part 110 of the abutment 100 may include a plurality of top protruding parts 150, which are spaced apart from each other on an upper end portion 111 having a horizontal surface shape and protrude upward. For example, when two top protruding parts 150 are provided, it is preferable that the top protruding parts 150 are disposed to face each other; when three top protruding parts 150 are provided, it is preferable that the top protruding parts 150 are disposed at the vertices of an equilateral triangle; and when four top protruding parts 150 are provided, it is preferable that the top protruding parts 150 are disposed at the vertices of a square.

A height of each top protruding part 150 may be, for example, 1 to 3 mm to ensure elasticity and prevent breakage when the prosthesis 200 is fastened. A width of each top protruding part 150 may be, for example, 0.5 to 2 mm to ensure elasticity when the prosthesis 200 is fastened.

In yet another embodiment, the top protruding part 150 may include a groove 151 recessed from an outer side. The groove 151 may be formed along an outer circumferential surface of the top protruding part 150. As described below, when the prosthesis 200 is coupled, a protrusion 221 formed in a coupling protrusion part 220 of the prosthesis 200 is inserted into the groove 151 of the top protruding part 150 and fastened thereto.

In yet another embodiment, the top protruding part 150 may be configured to elastically contract when the protrusion 221 of the coupling protrusion part 220 is inserted into and fastened to the grooves 151 of the top protruding parts 150. This is explained in more detail below.

In yet another embodiment, the top protruding part 150 may be configured to protrude upward while being spaced inward from an outer periphery 111a of the upper end portion 111 of the upper part 110 of the abutment 100. Due to this configuration, after the upper part 110 of the abutment 100 is inserted into and fastened to a coupling part 210 of the prosthesis 200, a predetermined gap H2 may be formed between at least a portion of a lower area of the groove 151 of the top protruding part 150 and the prosthesis 200. As this gap H2 is formed, a lateral pressure that may be applied to the top protruding part 150 due to a patient's chewing action after implant placement may be eliminated, thereby ensuring long-term use and facilitating repair of the prosthesis 200.

In yet another embodiment, the upper part 110 of the abutment 100 may include an inclined outer circumferential surface 113, which is configured to have a width increasing from the upper end portion 111 to a lower end portion 112 and connects the upper end portion 111 and the lower end portion 112. The upper part 110 of the abutment 100 may further include a rotation-preventing surface 114 formed by vertically and horizontally cutting a portion of the outer circumferential surface 113. The rotation-preventing surface 114 may prevent rotation of the prosthesis 200 that is inserted and fastened.

In yet another embodiment, an upper end portion of the top protruding part 150 may include a first horizontal region 152 formed as a horizontal surface.

Meanwhile, the inclined part 120 of the abutment 100 may be configured to connect the upper part 110 and the lower part 130 and to have a radius decreasing in a downward direction.

The lower part 130 of the abutment 100 may be configured to be inserted into and fastened to the fixture 300.

A first screw hole 140 may be formed in the center of the abutment 100. The abutment screw 400 which will be described later is inserted and fastened through the first screw hole 140.

According to one specific example of the present disclosure, a coupling part 210, which the upper part 110 of the abutment 100 is inserted into and fastened to, may be formed on an inner lower side of the prosthesis 200, and a second screw hole 240 may be formed on an inner upper side.

The prosthesis 200 may include the coupling protrusion part 220 that connects the coupling part 210 and the second screw hole 240. The coupling protrusion part 220 may include the protrusion 221 protruding into an interior of the prosthesis 200, and may be configured such that the protrusion 221 is inserted into and fastened to the groove 151 of the top protruding part 150 of the abutment 100. To explain in more detail, when the upper part 110 of the abutment 100 is inserted into the coupling part 210 of the prosthesis 200, the top protruding part 150 of the abutment 100 may elastically contract inward by the groove 151 formed along the outer circumferential surface and then restored to an original position thereof when the insertion is complete.

In one embodiment, the dental implant of the present disclosure may be configured such that after the upper part 110 of the abutment 100 is inserted into and fastened to the coupling part 210 of the prosthesis 200, the predetermined gap H1 is formed between at least a portion of the groove 151 of the top protruding part 150 and at least a portion of the protrusion 221 of the coupling protrusion part 220. Due to this configuration, lateral pressure that may be applied to the prosthesis 200 by the abutment screw 400, which will be described later, may be eliminated, thereby preventing damage to the prosthesis 200 during the placement of the implant. In addition, since the abutment 100 and the prosthesis 200 are fastened while a gap H is formed between the groove 151 and the protrusion 221, lateral pressure that may be applied to the top protruding part 150 due to a patient's chewing action after implant placement may be eliminated, thereby ensuring long-term use and facilitating repair of the prosthesis 200.

In yet another embodiment, an abutment seating portion 211 in which the outer circumferential surface 113 of the upper part 110 of the abutment 100 is closely seated may be formed in the coupling part 210 of the prosthesis 200. As described above, the outer circumferential surface 113 is configured to have a width increasing from the upper end portion 111 to the lower end portion 112, so the abutment seating portion 211 may also be configured to have a wider width that increases from an upper end to a lower end. When the abutment 100 is inserted into and fastened to the prosthesis 200, a downward force applied by the abutment screw 400 may be distributed to the abutment 100 and the prosthesis 200 to bring the outer circumferential surface 113 and the abutment seating portion 211 in close contact with each other, thereby preventing damage to the prosthesis 200.

In yet another embodiment, a screw seating portion 241 protruding into the interior of the prosthesis 200 may be formed in a lower side of the second screw hole 240. As shown in FIG. 3, an upper end surface of the screw seating portion 241 may protrude into the interior of the prosthesis 200 at a right angle, as indicated by a dotted circle, but the screw seating portion 241 may also be formed so that a lower end surface becomes wider in a downward direction. Due to this configuration, when the abutment screw 400 which will be described later is inserted and fastened, only a downward force is applied to the prosthesis 200 as the abutment screw 400 presses the screw seating portion 241. As a result, no lateral force is applied to the prosthesis 200, thereby preventing damage to the prosthesis 200 due to lateral pressure.

In yet another embodiment, a lower end portion of the screw seating portion 241 may include a second horizontal region 242 formed as a horizontal surface. Here, when the abutment screw 400 is inserted and fastened, the first horizontal region 152 and the second horizontal area 242 may be configured so as not to come into contact with each other. When the abutment screw 400 is inserted and fastened, a downward force is applied to the screw seating portion 241. However, since the first horizontal region 152 and the second horizontal area 242 are configured so as not to come into contact with each other, the downward force by the abutment screw 400 does not reach the top protruding part 150, and thus, damage to the top protruding part 150 may be prevented.

The abutment screw 400 according to one specific example of the present disclosure may be configured to be inserted and fastened through the first and second screw holes 140 and 240. That is, the abutment screw 400 may be inserted and fastened through the second screw hole 240 formed in the center of the prosthesis 200 and the first screw hole 140 formed in the center of the abutment 100, and then inserted into a screw groove formed in the center of the fixture 300.

In one embodiment, a distance L1 from a center A of the first screw hole 140 to an inner surface of the top protruding part 150 may be configured to be greater than or equal to a radius L2 of the area of the abutment screw 400 corresponding to a position of the top protruding part 150 when the abutment screw 400 is inserted and fastened. After the abutment 100 is inserted into and fastened to the prosthesis 200, a diameter L2×2 of the abutment screw 400 corresponding to the position of the top protruding part 150 is formed smaller than a distance L1×2 between the inner surfaces of the top protruding part 150, so that when the abutment screw 400 is inserted and fastened, a lateral pressure by the abutment screw 400 is not applied to the top protruding part 150, thereby preventing damage to the top protruding part 150.

Hereinafter, various embodiments of the present disclosure will be described.

(1) A dental implant comprising: an abutment (100) comprising an upper part (110) inserted into and fastened to a prosthesis (200), a lower part (130) inserted into and fastened to a fixture (300), an inclined part (120) connecting the upper part (110) and the lower part (130), and a first screw hole (140) formed in a center thereof; the prosthesis (200) comprising a coupling part (210) formed on an inner lower side, which the upper part (110) of the abutment (100) is inserted into and fastened to, a second screw hole (240) formed on an inner upper side, and a coupling protrusion part (220) connecting the coupling part (210) and the second screw hole (240); an abutment screw (400) inserted and fastened through the first and second screw holes (140, 240), wherein the upper part (110) of the abutment (100) comprises a plurality of top protruding parts (150), which are arranged to be spaced apart from each other at an upper end portion (111) having a horizontal surface shape and protrude upward, the top protruding parts (150) comprise grooves (151) recessed from outer sides thereof, and the coupling protrusion part (220) comprises a protrusion (221) protruding into an interior of the prosthesis (200) such that the protrusion (221) is inserted into and fastened to the grooves (151) of the top protruding parts (150).

(2) The dental implant, wherein the top protruding parts (150) are configured to elastically contract when the protrusion (221) of the coupling protrusion part (220) is inserted into and fastened to the grooves (151) of the top protruding parts (150).

(3) The dental implant, wherein after the upper part (110) of the abutment (100) is inserted into and fastened to the coupling part (210) of the prosthesis (200), a predetermined gap (H1) is formed between at least a portion of the grooves (151) of the top protruding parts (150) and at least a portion of the protrusion (221) of the coupling protrusion part (220).

(4) The dental implant, wherein the upper part (110) of the abutment (100) comprises an inclined outer circumferential surface (113), which is configured to have a width increasing from the upper end portion (111) to a lower end portion (112) and connects the upper end portion (111) and the lower end portion (112), and wherein an abutment seating portion (211) in which the outer circumferential surface (113) of the upper part (110) of the abutment (100) is closely seated is formed in the coupling part (210) of the prosthesis (200).

(5) The dental implant, wherein a screw seating portion (241) protruding into an interior of the prosthesis (200) is formed in the lower side of the second screw hole (240), and wherein the abutment screw (400) presses the screw seating portion (241), thereby applying only a downward force to the prosthesis (200) when the abutment screw (400) is inserted and fastened.

(6) The dental implant, wherein upper end portions of the top protruding parts (150) comprise first horizontal regions (152) formed as horizontal surfaces, wherein a lower end portion of the screw seating portion (241) comprises a second horizontal region (242) formed as a horizontal surface, and wherein the first horizontal regions (152) and the second horizontal region (242) do not come into contact when the abutment screw (400) is inserted and fastened.

(7) The dental implant, wherein a distance (L1) from a center (A) of the first screw hole (140) to inner surfaces of the top protruding parts (150) is greater than or equal to a radius (L2) of an area of the abutment screw (400) corresponding to positions of the top protruding parts (150) when the abutment screw (400) is inserted and fastened.

(8) The dental implant, wherein the top protruding parts (150) are configured to protrude upward while being spaced inward from an outer periphery (111a) of the upper end portion (111) of the upper part (110) of the abutment (100), and wherein after the upper part (110) of the abutment (100) is inserted into and fastened to the coupling part (210) of the prosthesis (200), a predetermined gap (H2) is formed between at least a portion of a lower area of the grooves (151) of the top protruding parts (150) and the prosthesis.

### DESCRIPTION OF REFERENCE NUMERALS

100: abutment, 150: top protruding part, 151: groove, 200: prosthesis, 210: coupling part, 220: coupling protrusion part, 300: fixture, 400: abutment screw

1.-8. (canceled)

9. A dental implant comprising:
an abutment comprising an upper part inserted into and fastened to a prosthesis, a lower part inserted into and fastened to a fixture, an inclined part connecting the upper part and the lower part, and a first screw hole formed in a center thereof;
the prosthesis comprising a coupling part formed on an inner lower side, which the upper part of the abutment is inserted into and fastened to, a second screw hole formed on an inner upper side, and a coupling protrusion part connecting the coupling part and the second screw hole; and
an abutment screw inserted and fastened through the first and second screw holes,
wherein the upper part of the abutment comprises a plurality of top protruding parts, which are arranged to be spaced apart from each other at an upper end portion having a horizontal surface shape and protrude upward, the top protruding parts comprise grooves recessed from outer sides thereof, and the coupling protrusion part comprises a protrusion protruding into an interior of the prosthesis such that the protrusion is inserted into and fastened to the grooves of the top protruding parts.

10. The dental implant of claim 9, wherein the top protruding parts are configured to elastically contract when the protrusion of the coupling protrusion part is inserted into and fastened to the grooves of the top protruding parts.

11. The dental implant of claim 10, wherein after the upper part of the abutment is inserted into and fastened to the coupling part of the prosthesis, a predetermined gap (H1) is formed between at least a portion of the grooves of the top protruding parts and at least a portion of the protrusion of the coupling protrusion part.

12. The dental implant of claim 9, wherein the upper part of the abutment comprises an inclined outer circumferential surface, which is configured to have a width increasing from the upper end portion to a lower end portion and connects the upper end portion and the lower end portion, and wherein an abutment seating portion in which the outer circumferential surface of the upper part of the abutment is closely seated is formed in the coupling part of the prosthesis.

13. The dental implant of claim 9, wherein a screw seating portion protruding into an interior of the prosthesis is formed in the lower side of the second screw hole, and
wherein the abutment screw presses the screw seating portion, thereby applying only a downward force to the prosthesis when the abutment screw is inserted and fastened.

14. The dental implant of claim 13, wherein upper end portions of the top protruding parts comprise first horizontal regions formed as horizontal surfaces,
wherein a lower end portion of the screw seating portion comprises a second horizontal region formed as a horizontal surface, and
wherein the first horizontal regions and the second horizontal region do not come into contact when the abutment screw is inserted and fastened.

15. The dental implant of claim 9, wherein a distance (L1) from a center (A) of the first screw hole to inner surfaces of the top protruding parts is greater than or equal to a radius (L2) of an area of the abutment screw corresponding to positions of the top protruding parts when the abutment screw is inserted and fastened.

16. The dental implant of claim 10, wherein the top protruding parts are configured to protrude upward while being spaced inward from an outer periphery of the upper end portion of the upper part of the abutment, and
wherein after the upper part of the abutment is inserted into and fastened to the coupling part of the prosthesis, a predetermined gap (H2) is formed between at least a portion of a lower area of the grooves of the top protruding parts and the prosthesis.
